(19) United States
(12) Patent Application Publication
(10) Pub. No.: US 2015/0138485 A1
(43) Pub. Date: May 21, 2015

(54) LIQUID CRYSTAL DISPLAY DEVICE

(71) Applicant: Sharp Kabushiki Kaisha, Osaka (JP)

(72) Inventor: Yusuke Masuda, Osaka (JP)

(73) Assignee: SHARP KABUSHIKI KAISHA, Osaka (JP)

(21) Appl. No.: 14/406,911

(22) PCT Filed: Jun. 6, 2013
(86) PCT No.: PCT/JP2013/065703

§ 371 Date: Dec. 10, 2014

(30) Foreign Application Priority Data
Jun. 13, 2012 (JP) 2012-133840

(51) Int. Cl. G02F 1/1335; F21V 8/00; G02F 1/1333

(52) U.S. Cl. CPC G02F 1/133512; G02F 1/133308; G02F 1/133504; G02B 6/0055; G02F 2001/133314; G02F 2001/13332; G02F 2001/133354
USPC 349/58

(57) ABSTRACT

A liquid crystal display device of the present invention reduces light leakage from a backlight. A liquid crystal display device is provided with: a front case that has an opening; a rear case that is combined with the front case; a liquid crystal panel that is arranged between the front case and the rear case; a backlight unit that is arranged between the liquid crystal panel and the rear case; and a light-shielding member that is arranged between the front case and the backlight unit and that is in contact with the front case and the backlight unit. The light-shielding member is in contact with the periphery of the rear case side surface of the liquid crystal panel.

### TECHNICAL FIELD

The present invention is related to a liquid crystal display device having a backlight.

### BACKGROUND ART

A problem that arises when narrowing the frame of a liquid crystal display device is that light from the backlight becomes more likely to leak from the periphery of the display area.

Japanese Patent Application Laid-Open Publication No. 2002-174811 discloses a liquid crystal display device that can prevent light from the illumination unit leaking around the image display area. In this liquid crystal display device, a reflection preventing member is disposed around an opening of the metallic case of the illumination unit such that the reflection preventing member overlaps the black matrix that is around the image display area of the liquid crystal panel. Also, a light-shielding film is bonded to the front cover disposed on the upper side of the liquid crystal panel so as to overlap the liquid crystal panel. The reflection preventing member is coated onto the edge face of the liquid crystal panel.

### SUMMARY OF THE INVENTION

The liquid crystal display device described in the above-mentioned Patent Document needs to be coated with a reflection preventing member or the like and therefore causes the number of manufacturing steps to increase.

The object of the present invention is to obtain a configuration of a liquid crystal display device in which light leakage from the backlight is reduced.

The liquid crystal display device described here has a front case having an opening, a rear case that joins with the front case, a liquid crystal panel disposed between the front case and the rear case, a backlight unit disposed between the liquid crystal panel and the rear case, and a light-shielding member that is disposed between the front case and the backlight unit and that is in contact with the front case and the backlight unit. The light-shielding member is in contact with the periphery of a surface of the liquid crystal panel facing the rear case.

According to the present invention, a configuration of a liquid crystal display device that reduces light leakage from the backlight can be attained.

### BRIEF DESCRIPTION OF THE DRAWINGS

FIG. 1 is an exploded perspective view that shows a schematic configuration of a liquid crystal display device of Embodiment 1 of the present invention.

FIG. 2 is a schematic plan view showing an area A of FIG. 1 that has been magnified.

FIG. 3 is a cross-sectional view of FIG. 2 along the line III-III.

FIG. 4 is a cross-sectional view of FIG. 2 along the line IV-IV.

FIG. 5 is a cross-sectional view that schematically shows a configuration of the liquid crystal display device of the first comparison example.

FIG. 6 is a cross-sectional view that schematically shows a configuration of the liquid crystal display device of the second comparison example.

FIG. 7 is a cross-sectional view that shows a schematic configuration of a liquid crystal display device of Embodiment 2 of the present invention.

FIG. 8 is a cross-sectional view that shows a schematic configuration of a liquid crystal display device of Embodiment 3 of the present invention.

### DETAILED DESCRIPTION OF EMBODIMENTS

The liquid crystal display device of one embodiment of the present invention has a front case having an opening; a rear case combined with the front case; a liquid crystal panel disposed between the front case and the rear case; a backlight unit disposed between the liquid crystal panel and the rear case; and a light-shielding member that is disposed between the front case and the backlight unit and that contacts the front case and the backlight unit, wherein the light-shielding member is in contact with a periphery of a surface of the liquid crystal panel facing the rear case (first configuration).

According to this configuration, the light-shielding member is disposed between the front case and the backlight unit and is in contact with the front case and the backlight unit. In addition, the light-shielding member is in contact with the periphery of a surface on the rear case side of the liquid crystal panel. As a result, light emitted from the backlight unit enters from the surface on the rear case side of the liquid crystal panel. In other words, the light emitted from the backlight unit is blocked by the light-shielding member and does not travel outside from the periphery of the liquid crystal panel. As a result, the light emitted from the backlight unit is prevented from entering through a side face of the liquid crystal panel, and thus light leakage from the periphery of the liquid crystal panel can be reduced.

In the first configuration, it is preferable that the liquid crystal display device further includes an optical sheet disposed between the liquid crystal panel and the backlight unit, wherein the optical sheet is sandwiched between the liquid crystal panel and the backlight unit (second configuration).

According to the configuration above, wrinkling of the optical sheets due to thermal expansion and contraction can be suppressed.

In the first or the second configuration, it is preferable that a portion of the light-shielding member that is in contact with the liquid crystal panel in a plan view be not in contact with the backlight unit (third configuration).

The light-shielding member is in contact with the case and the backlight unit. In other words, the light-shielding member regulates the size of the gap between the front case and the backlight unit. Meanwhile, according to the configuration, pressure from the backlight unit is not added to the liquid crystal panel through the light-shielding member. Therefore, it is unnecessary to dispose a cushioning material or the like between the light-shielding member and the liquid crystal panel.

According to any one of the first to third configurations, it is preferable that the light-shielding member be fixed to the front case (fourth configuration).

According to the configuration above, positioning of the light-shielding member during assembly of the liquid crystal display device can be accomplished with ease, thereby improving productivity.

In the fourth configuration, the front case may have a projection having an opening therein, and the light-shielding member may have a protrusion that engages the opening in the projection (fifth configuration).

In any one of the first to fifth configurations, it is preferable that the light-shielding member have a guide portion that is formed along a periphery of the backlight unit (sixth configuration).

According to the configuration above, positioning of the backlight unit during assembly of the liquid crystal display device can be accomplished with ease, thereby improving productivity.

In the second configuration, it is preferable that the light-shielding member be formed along a periphery of the optical sheet (seventh configuration).

According to the configuration above, positioning of the optical sheets during assembly of the liquid crystal display device can be accomplished with ease, thereby improving productivity.

### EMBODIMENTS

Embodiments of the present invention will be described in detail below with reference to the drawings. Portions in the drawings that are the same or similar are assigned the same reference characters and descriptions thereof will not be repeated. For ease of description, drawings referred to below show simplified or schematic configurations, and some of the components are omitted. Components shown in the drawings are not necessarily to scale.

### Embodiment 1

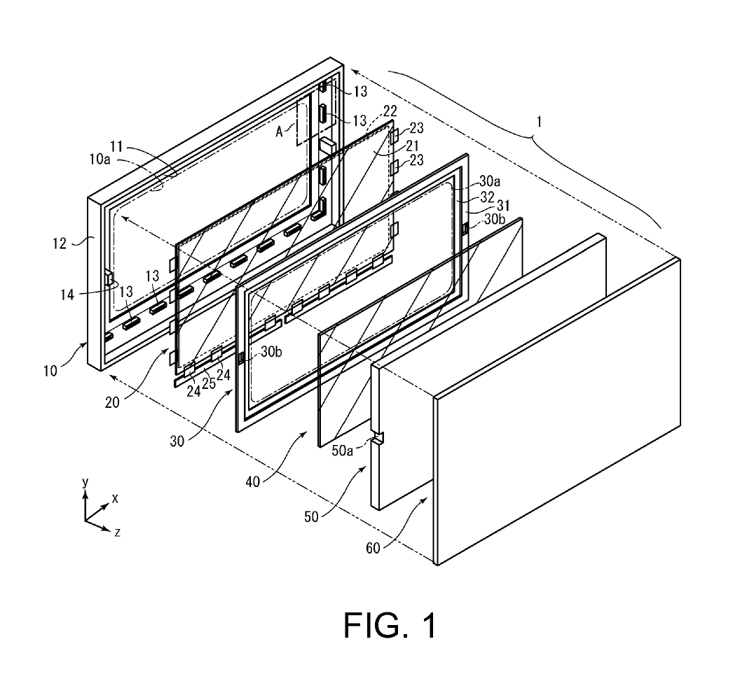

FIG. 1 is an exploded perspective view that shows a schematic configuration of a liquid crystal display device 1 of Embodiment 1 of the present invention. The liquid crystal display device 1 has a bezel (front case) 10, a liquid crystal panel unit (liquid crystal panel) 20, a light-shielding member 30, optical sheets 40, a backlight unit 50, and a backlight chassis (rear case) 60.

The liquid crystal display device 1 is made by assembling the liquid crystal panel unit 20, the light-shielding member 30, the optical sheets 40, the backlight unit 50, and the backlight chassis 60 in the bezel 10 in that order.

The bezel 10 is in a frame shape. More specifically, the bezel 10 includes a plate-shaped portion 11 that has a substantially rectangular shape in a plan view, and a wall portion 12 formed on the periphery of the plate-shaped portion 11. The plate-shaped portion 11 has formed therein an opening 10a. The bezel 10 and the backlight chassis 60 together form the case of the liquid crystal display device 1.

Below, as shown in FIG. 1, the longer side direction of the plate-shaped portion 11 is referred to as the x direction and the shorter side direction is referred to as the y direction. The direction perpendicular to the plate-shaped portion 11 is referred to as the z direction. Furthermore, as for the z direction, the direction from the bezel 10 to the backlight chassis 60 is referred to as the plus direction of the z direction and the opposite direction thereof is referred to as the minus direction of the z direction.

A plurality of projections 13 and 14 are formed on the plus direction side in the z direction of the surface of the plate-shaped portion 11 (the backlight chassis 60 side). As mentioned later, the projections 13 are used to fix the light-shielding member 30 and the projections 14 are used to regulate the position of the backlight unit 50.

The bezel 10 is formed of metal such as aluminum, for example. The plate-shaped portion 11, the wall portion 12, and the projections 13 and 14 may be formed integrally or formed as separate parts.

The liquid crystal panel unit 20 has an array substrate 21, a color filter substrate 22, a gate driver tab 23, a source driver tab 24, and a source substrate 25.

A detailed configuration is not shown, but the array substrate 21 includes a transparent substrate, pixel electrodes, and wiring lines (source lines and gate lines) to control the pixel electrodes and switching elements. A detailed configuration is not shown, but the color filter substrate 22 has a transparent substrate, a common electrode, a color filter, and a black matrix.

The array substrate 21 and the color filter substrate 22 are bonded to each other such that a liquid crystal layer (not shown) is sandwiched therebetween. The area of the array substrate 21 is larger than the area of the color filter substrate 22, and the periphery of the array substrate 21 protrudes from the color filter substrate 22.

The gate driver tabs 23 and the source driver tabs 24 are formed on a portion of the array substrate 21 protruding from the color filter substrate 22. As shown in FIG. 1, the plurality of gate driver tabs 23 are formed at edge portions in the x direction of both sides of the array substrate 21 so as to be aligned along the y direction. In a similar manner, a plurality of source driver tabs 24 are aligned along the x direction at an edge portion in the y direction of the array substrate 21. The gate driver tabs 23 may be formed on just one edge portion in the x direction of the array substrate 21.

The gate driver tabs 23 and the source driver tabs 24 include a polyimide film, and an electrode and an LSI (large scale integration) chip that are formed on the film. The gate driver tabs 23 include gate driver chips that drive the gate lines of the array substrate 21. The source driver tabs 24 include source driver chips that drive the source lines of the array substrate 21.

The source driver tabs 24 are connected to the source substrate 25. The source substrate 25 is a glass epoxy substrate, for example. A detailed configuration is not shown, but the source substrate 25 has a control circuit, a high voltage generator, and a connector formed thereon. The liquid crystal panel unit 20 may further include a gate substrate connected to the gate driver tabs.

The liquid crystal panel unit 20 is disposed such that a display area (active area) of the liquid crystal panel unit 20 and an opening 10a formed in the bezel 10 overlap. The projections 13 and 14 of the bezel 10 are disposed so as to be between the gate driver tabs 23 or the source driver tabs 24. Thus, the projections 13 and 14 of the bezel 10 do not touch the gate driver tabs 23, the source driver tabs 24, and the source substrate 25.

The light-shielding member 30 has a frame shaped opening 30a. The area of the light-shielding member 30 is larger than the area of the array substrate 21 and the area of the opening 30a is smaller than the area of the array substrate 21. Thus, the periphery of the array substrate 21 overlaps the light-shielding member 30 in a plan view.

More specifically, the light-shielding member 30 includes a main body 31 and a protective member 32. The protective member 32 is formed in the inner side of the main body 31 and covers the periphery of the array substrate 21. The protective member 32 is thinner (has a smaller dimension in the z direction) than the main body 31.

The light-shielding member 30 has an opening 30b so as not to touch the projections 14 of the bezel 10.

This is not shown in FIG. 1, but a plurality of protrusions are formed on the minus direction surface (bezel 10 side surface) of the z direction of the light-shielding member 30. Details will be mentioned later, but each of the protrusions is respectively formed to be engaged with the respective openings in the projections 13 of the bezel 10 side.

The light-shielding member 30 has light-shielding characteristics. The light-shielding member 30 is a molded body of resin with black pigment being added, for example.

The optical sheet 40 is disposed between the liquid crystal panel unit 20 and the backlight unit 50, and the backlight unit 50 improves the characteristics of the light radiated from the backlight unit 50. The optical sheet 40 is a diffusion sheet and a prism sheet, for example. The optical sheet 40 may be one sheet or may be a sheet with two or more types of sheets combined.

The area of the optical sheet 40 is smaller than the area of the opening 30a in the light-shielding member 30. As mentioned later, the optical sheet 40 is in contact with both the array substrate 21 and the backlight unit 50. In other words, the optical sheet 40 is sandwiched between the array substrate 21 and the backlight unit 50.

The detailed configuration of the backlight unit 50 is not shown, but the backlight unit 50 includes a light source, a light guide plate, and a reflective sheet. In other words, the backlight unit 50 is an edge-lit backlight unit and converts the light from the light source to planar light source. The light source is an LED (light emission diode), the light guide plate is a molded body of acrylic resin, and the reflective film is a white polyester film, for example.

The backlight unit 50 is not limited to an edge-lit backlight, and may be a direct-lit backlight or a planar light backlight.

The backlight unit 50 has a recess portion 50a. The recess portion 50a is formed in a position that corresponds to the projections 14 of the bezel 10. By engaging the projection 14 of the bezel 10 with the recess portion 50a, the position of the backlight unit 50 in the x direction and the y direction is regulated.

The backlight chassis 60 has a plate shape that is a substantially rectangular shape in a plan view. The bezel 10 and the backlight chassis 60 together form the case of the liquid crystal display device 1, as described above. The backlight chassis 60 is made of resin, for example.

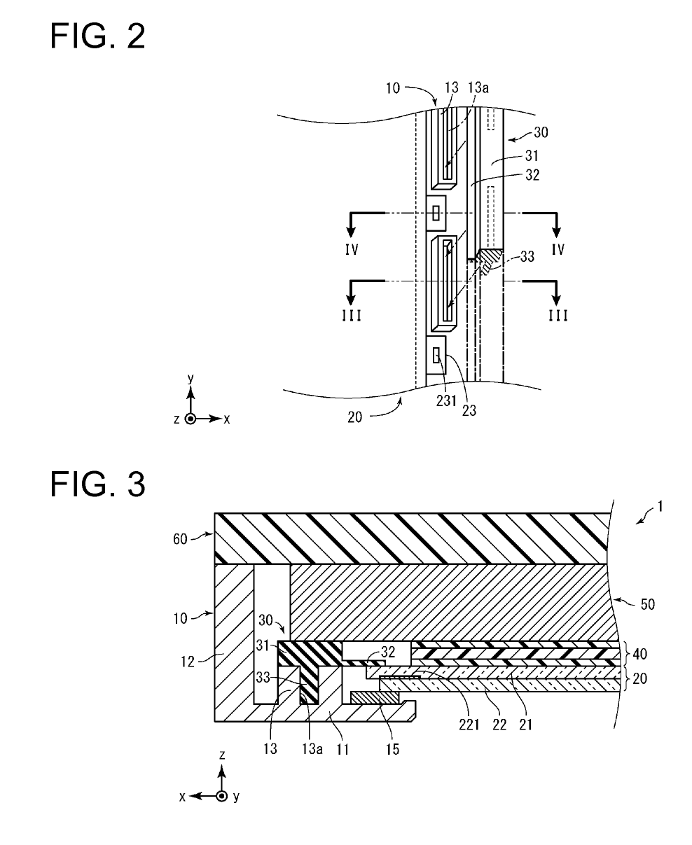

FIG. 2 is a schematic plan view showing an area A of FIG. 1 that has been magnified. FIG. 2 shows a state in which the liquid crystal panel unit 20 is attached to the bezel 10. FIG. 2 schematically shows the light-shielding member 30 and the cross-section of the light-shielding member 30. As mentioned before, the projections 13 of the bezel 10 are located between the gate driver tabs 23 of the liquid crystal panel unit 20, and therefore do not touch the gate driver tabs 23. A plurality of projections 33 are formed on the minus direction surface (surface on the bezel 10 side) in the z direction of the light-shielding member 30. The respective protrusions 33 of the bezel 10 are formed so as to engage with the openings 13a formed in the projections 13.

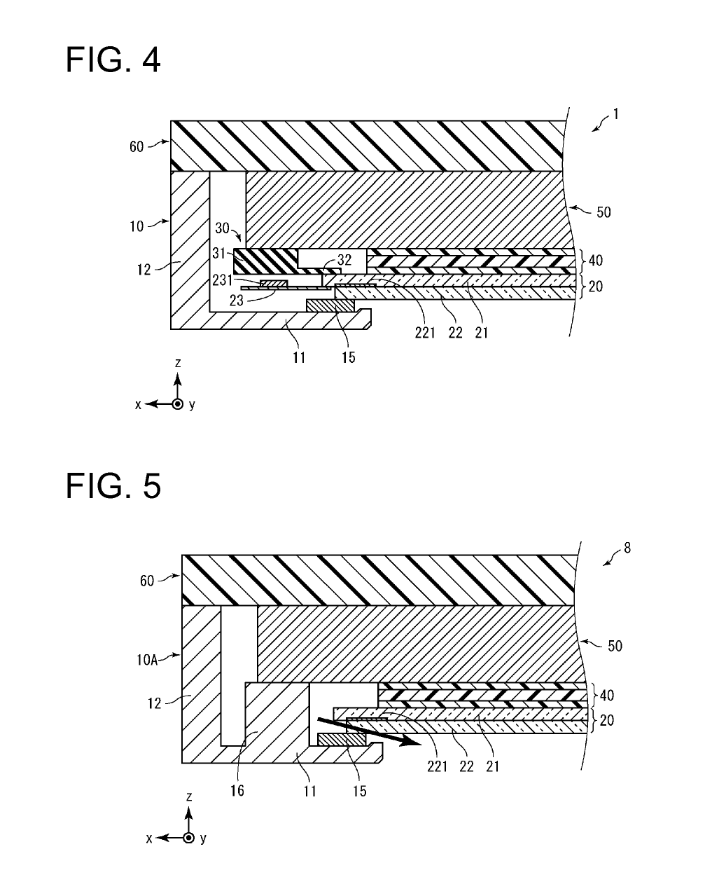

FIG. 3 is a cross-sectional view of FIG. 2 along the line III-III, and FIG. 4 is a cross-sectional view of FIG. 2 along the line IV-IV. As shown in FIGS. 3 and 4, the upper edge surface (edge surface on the plus direction side in the z direction) of the projections 13 is located farther towards the backlight chassis 60 than the gate driver tabs 23. As a result, the main body 31 of the light-shielding member 30 and the protective member 32 are disposed farther towards the backlight chassis 60 than the gate driver tabs 23 and the gate driver chips 231 formed on the gate driver tabs 23. Thus, the light-shielding member 30 does not touch the gate driver tabs 23 and the gate driver chips 231. This is not shown, but in a similar manner, the light-shielding member 30 does not touch the source driver tabs 24 and the source driver chips formed on the source driver tabs 24.

The main body 31 of the light-shielding member 30 is in contact with the backlight unit 50. The main body 31 of the light-shielding member 30 is sandwiched by the projections 13 of the bezel 10 and the backlight unit 50. In other words, the light-shielding member 30 regulates the gap between the bezel 10 and the backlight unit 50.

The protective member 32 of the light-shielding member 30 is in contact with the plus direction surface (backlight chassis 60 side surface) of the array substrate 21 of the liquid crystal panel unit 20. The protective member 32 covers the periphery of the array substrate 21.

The protective member 32 is made thinner than the main body 31 (z direction dimension is small). Therefore, the protective member 32 is not in contact with the backlight unit 50. In other words, the portion of the light-shielding member 30 that is in contact with the array substrate 21 (protective member 32) in a plan view is not in contact with the backlight unit 50.

The backlight unit 50 is sandwiched and held by the main body 31 of the light-shielding member 30 and the backlight chassis 60. In other words, the backlight unit 50 is fixed by the backlight chassis 60 that presses the backlight unit 50 to the bezel 10 side. The backlight chassis 60 is fixed by a screw or the like to the bezel 10, for example.

The array substrate 21, the color substrate 22, and the optical sheet 40 are sandwiched and held by the plate-shaped portion 11 of the bezel 10 and the backlight unit 50. More specifically, a cushioning material 15 is disposed between the color filter substrate 22 and the plate-shaped portion 11.

The optical sheet 40 is in contact with both the array substrate 21 of the liquid crystal panel unit 20 and the backlight unit 50. In other words, the optical sheet 40 is sandwiched between the array substrate 21 and the backlight unit 50. The gap between the liquid crystal panel unit 20 and the backlight unit 50 is appropriately maintained by the cushioning material 15 by compression transformation thereof. Due to this configuration, the optical sheet 40 can be attached to the array substrate 21 and the backlight unit 50.

The schematic configuration of the liquid crystal display device 1 of Embodiment 1 of the present invention has been described above. According to the present embodiment, the protective member 32 of the light-shielding member 30 is in contact with the periphery of the surface of the array substrate 21 on the backlight chassis 60 side of the liquid crystal panel unit 20. As a result, the light radiated from the backlight unit 50 enters from the surface of the array substrate 21 on the backlight chassis 60 side. In other words, light radiated from the backlight unit 50 is blocked by the light-shielding member 30 and does not travel outside from the periphery of the array substrate 12. Thus, the light that is radiated from the backlight unit 50 is prevented from entering the array substrate 21 or a side face of the color filter substrate 22. Therefore, light leakage from the peripheries of the array substrate 21 and the color filter substrate 22 can be reduced.

It is preferable that the protective member 32 cover the entire periphery of the array substrate 21. It is preferable that the protective member 32 be formed such that a portion thereof overlaps a black matrix 221 formed on the periphery of the color filter substrate 22. As a result, light can be made not to leak from the gap.

Light leakage becomes more likely if the light guide plate has recesses and protrusions in a surface thereof like the recess 50a of the backlight unit 50 (see FIG. 1). However, according to the present embodiment, even if light leaks from a side face of the light guide plate, the light can be blocked by the light-shielding member 30. Therefore, the effect of light leaking does not need to be taken into consideration, and thus the degree of design freedom of the backlight unit 50 can be increased.

The light-shielding member 30 is fixed to the bezel 10 by the protrusions 33. Through this configuration, the position of the light-shielding member 30 can be fixed accurately. Productivity during assembly also improves.

The projections 13 formed on the bezel 10 engage the protrusions 33 and fix the light-shielding member 30. The projections 13 also have the role of making sure that the light-shielding member 30 does not touch the gate driver tabs 23 of the liquid crystal panel unit 20 and the source driver tabs 24.

If the light-shielding member 30 is in a sheet shape, the handling thereof becomes difficult due to the light-shielding member 30 curling up, wrinkling, and the like. In this case, productivity decreases as the area of the light-shielding member 30 increases. According to the present embodiment, the light-shielding member 30 has recesses and protrusions in the cross-sectional shape thereof due to the main body 31 and the protrusions 33. As a result, the shape can be maintained better than a sheet shape, and thus is easier to use. Therefore, productivity during assembly improves.

The light-shielding member 30 also has the role of regulating the gap between the bezel 10 and the backlight unit 50. The number of parts can be reduced compared to a case in which the gap between the bezel 10 and the backlight unit 50 is set by a separate part.

The main body 31 of the light-shielding member 30 is sandwiched and held by the backlight chassis 60 and the backlight unit 50. Meanwhile, the protective member 32 of the light-shielding member 30 is not in contact with the light guide plate 50. As a result, the pressure from the backlight unit 50 is not added to the array substrate 21 of the liquid crystal panel unit 20 and the color filter substrate 22. Therefore, there is no need to dispose a cushioning material or the like between the light-shielding member 30 and the liquid crystal panel unit 20.

According to the present embodiment, the optical sheet 40 can be attached to the array substrate 21 and the backlight unit 50. As a result, no wrinkles occur even if the optical sheet 40 deforms due to thermal expansion. Thus, excellent display characteristics can be maintained. Preferably, the entire surface of the optical sheet 40 should be attached to the array substrate 21 and the backlight unit 50. As a result, the occurrence of wrinkles is further suppressed.

### Comparison Example 1

Next, in order to explain the effects of the present embodiment, a description of a hypothetical comparison example will be described. FIG. 5 is a cross-sectional view that schematically shows a configuration of a liquid crystal display device 8 of the first comparison example. Compared to the liquid crystal display device 1, the liquid crystal display device 8 does not have the light-shielding member 30, and has a bezel 10A instead of the bezel 10.

The bezel 10A has projections 16 instead of the projections 13 of the bezel 10. The liquid crystal display device 8 regulates the gap between the plate-shaped portion 11 of the bezel 10 and the backlight unit 50 by using the projections 16.

As shown in FIG. 5 as an arrow, in the configuration of the liquid crystal display device 8, a portion of the light radiated from the backlight unit 50 enters the array substrate 21 or the side face of the color filter substrate 22. As a result, a light leakage is perceived in some cases if viewed from a diagonal angle to the direction normal to the array substrate 21 and the color filter substrate 22. Light leakage is especially pronounced when the width of the black matrix 221 is narrow and the opening 10a of the bezel 10 is large, or in other words, if the frame is narrow.

### Comparison Example 2

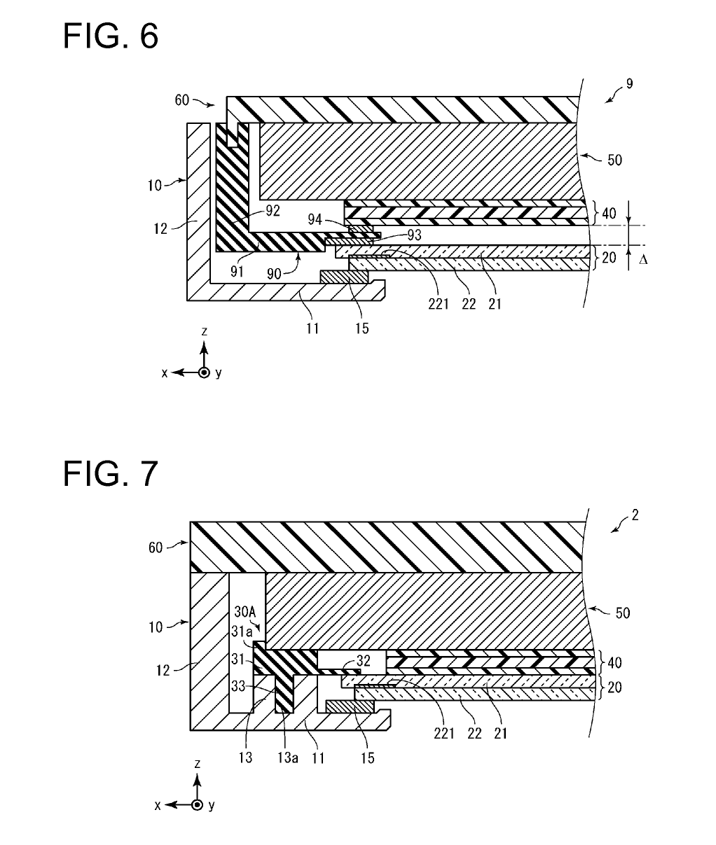

FIG. 6 is a cross-sectional view that schematically shows a configuration of a liquid crystal display device 9 of the second comparison example. Instead of the light-shielding member 30 of the liquid crystal display device 1, the liquid crystal display device 9 is provided with a panel holder 90.

The panel holder 90 includes a plate-shaped portion 91 having an opening and a wall portion 92 formed on the periphery of the plate-shaped portion 91. The area of the plate-shaped portion 91 is larger than the area of the array substrate 21 and the area of the opening of the plate-shaped portion 91 is smaller than the area of the array substrate 21. Therefore, the plate-shaped portion 91 is in contact with the periphery of the array substrate 21.

The edge portion of the wall portion 92 of the panel holder 90 is fixed to the backlight chassis 60. Due to this configuration, the panel holder 90 regulates the gap between the backlight chassis 60 and the array substrate 21.

In the liquid crystal display device 9, the plate-shaped portion 91 covers the edge portion of the array substrate 21, and thus light leakage does not occur.

Meanwhile, the plate-shaped portion 91 is in contact with the respective peripheries of the array substrate 21 and the optical sheet 40. As a result, stress is concentrated at these peripheries of the array substrate 21 and the optical sheet 40. Therefore, there is a need to respectively dispose a cushioning material 93 between the frame-shaped portion 91 and the array substrate 21 and a cushioning material 94 between the frame-shaped portion 91 and the optical sheet 40.

In the configuration of the liquid crystal display device 9, the optical sheet 40 is not attached to the array substrate 21 because the plate-shaped portion 91 of the panel holder 90 is disposed between the optical sheet 40 and the array substrate 21. As shown in FIG. 6, a clearance A exists between the optical sheet 40 and the array substrate 21. Thus, the optical sheet 40 deforms due to thermal expansion and causes wrinkles in some cases.

Details of the configuration of hypothetical comparison examples have been given. In comparison to these liquid crystal display devices, according to the configuration of the liquid crystal display device 1 of the present embodiment, the state in which the array substrate 21 and the optical sheet 40 are in contact can be maintained while also preventing light leakage.

### Embodiment 2

FIG. 7 is a cross-sectional view that shows a schematic configuration of a liquid crystal display device 2 of Embodiment 2 of the present invention. Instead of the light-shielding member 30 of the liquid crystal display device 1, the liquid crystal display device 2 is provided with a light-shielding member 30A.

In addition to the structures included in the light-shielding member 30, the light-shielding member 30A also has a guide portion 31a that is formed on the periphery of the edge face towards the plus direction of the z direction (backlight chassis 60 side) of the main body 31. A guide portion 31a is formed along the periphery of the backlight unit 50. In other words, the light-shielding member 30 is formed such that the main body 31 and the guide portion 31a form a recess that engages the backlight unit 50.

According to the present embodiment, the position of the backlight unit 50 in the x direction or the y direction is regulated by the guide portion 31a. As a result, the projections 14 of the bezel 10 do not need a recess 50a (see FIG. 1) in the backlight unit 50. Furthermore, during assembly, the backlight unit 50 is positioned with ease, thereby improving productivity.

The guide portion 31a does not need to be in contact with the backlight unit 50. In other words, there may be a clearance for an area within the engineering tolerance of the shift in position of the backlight unit 50. This clearance allows the thermal expansion of the backlight unit 50 and the guide portion 31a.

### Embodiment 3

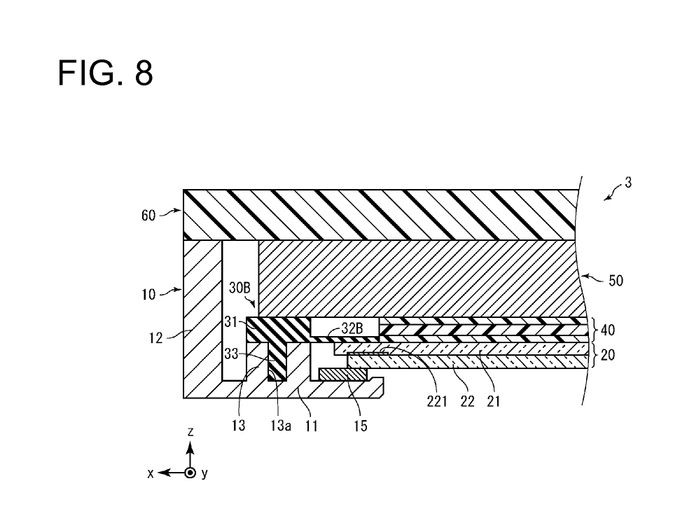

FIG. 8 is a cross-sectional view that shows a schematic configuration of a liquid crystal display device 3 of Embodiment 3 of the present invention. Instead of the light-shielding member 30 of the liquid crystal display device 1, the liquid crystal display device 3 is provided with a light-shielding member 30B.

The light-shielding member 30B has a protective member 32B instead of the protective member 32 of the light-shielding member 30. The protective member 32B is formed along the periphery of an optical sheet 40.

According to the present embodiment, during assembly, the position of the optical sheet 40 can be defined with ease by the protective member 32B, thereby improving productivity.

The protective member 32B does not need to be in contact with the optical sheet 40. In other words, there may be a clearance within the tolerance area of the shift in position of the optical sheet 40. This clearance allows thermal expansion of the optical sheet 40 and the protective member 32B.

### Other Embodiments

The embodiments of the present invention were described above, but the present invention is not limited to the embodiments above, and various modifications are possible within the scope of the present invention. The respective embodiments can also be appropriately combined.

### INDUSTRIAL APPLICABILITY

The present invention can be applied as a liquid crystal display device having a backlight.

1. A liquid crystal display device, comprising:
a front case having an opening;
a rear case combined with the front case;
a liquid crystal panel disposed between the front case and the rear case;
a backlight unit disposed between the liquid crystal panel and the rear case; and
a light-shielding member that is disposed between the front case and the backlight unit and that contacts the front case and the backlight unit,
wherein the light-shielding member is in contact with a periphery of a surface of the liquid crystal panel facing the rear case.

2. The liquid crystal display device according to claim 1, further comprising:
an optical sheet disposed between the liquid crystal panel and the backlight unit,
wherein the optical sheet is sandwiched between the liquid crystal panel and the backlight unit.

3. The liquid crystal display device according to claim 1, wherein a portion of the light-shielding member that is in contact with the periphery of the surface of the liquid crystal panel is not in contact with the backlight unit.

4. The liquid crystal display device according to claim 1, wherein the light-shielding member is fixed to the front case.

5. The liquid crystal display device according to claim 4,
wherein the front case has a projection on a rear side having an opening therein, and
wherein the light-shielding member has a protrusion that engages the opening in the projection.

6. The liquid crystal display device according to claim 1, wherein the light-shielding member has a guide portion that is formed along a periphery of the backlight unit to position the backlight unit.

7. The liquid crystal display device according to claim 2, wherein the light-shielding member is formed along a periphery of the optical sheet.

8. The liquid crystal display device according to claim 2, wherein a portion of the light-shielding member that is in contact with the periphery of the surface of the liquid crystal panel is not in contact with the backlight unit.

9. The liquid crystal display device according to claim 2, wherein the light-shielding member is fixed to the front case.

10. The liquid crystal display device according to claim 3, wherein the light-shielding member is fixed to the front case.

11. The liquid crystal display device according to claim 8, wherein the light-shielding member is fixed to the front case.

12. The liquid crystal display device according to claim 9,
wherein the front case has a projection on a rear side having an opening therein, and
wherein the light-shielding member has a protrusion that engages the opening in the projection.

13. The liquid crystal display device according to claim 10,
wherein the front case has a projection on a rear side having an opening therein, and
wherein the light-shielding member has a protrusion that engages the opening in the projection.

14. The liquid crystal display device according to claim 11,
wherein the front case has a projection on a rear side having an opening therein, and
wherein the light-shielding member has a protrusion that engages the opening in the projection.

15. The liquid crystal display device according to claim 2, wherein the light-shielding member has a guide portion that is formed along a periphery of the backlight unit to position the backlight unit.

16. The liquid crystal display device according to claim 3, wherein the light-shielding member has a guide portion that is formed along a periphery of the backlight unit to position the backlight unit.

17. The liquid crystal display device according to claim 4, wherein the light-shielding member has a guide portion that is formed along a periphery of the backlight unit to position the backlight unit.

18. The liquid crystal display device according to claim 5, wherein the light-shielding member has a guide portion that is formed along a periphery of the backlight unit to position the backlight unit.
